(19) United States
(12) Patent Application Publication
(10) Pub. No.: US 2009/0019119 A1
(43) Pub. Date: Jan. 15, 2009

(54) SYSTEM AND METHOD FOR DETECTING ONE OR MORE MISSING ATTACHMENTS OR EXTERNAL REFERENCES IN COLLABORATION PROGRAMS

(76) Inventor: Lee J. Scheffler, West Newton, MA (US)

Correspondence Address: HOFFMAN WARNICK LLC, 75 STATE STREET, 14TH FLOOR, ALBANY, NY, 12207, US

(21) Appl. No.: 11/777,306

(22) Filed: Jul. 13, 2007

(51) Int. Cl. G06F 15/16

(52) U.S. Cl. 709/206

(57) ABSTRACT

A system and method provide an enhancement to electronic mail programs, messaging and collaboration programs that scan the sender's message text and determines that the sender intended to attach one or more attachments or include one or more external references, but no attachment or reference has been included, and warns the user before sending. The system and method identify variants of typical phraseology such as “attached is . . . ”, “Here is . . . ”, “This file . . . ”, “take a look at this . . . ”, etc., and determines that it was likely that the user meant to attach or refer to something.

### FIELD OF INVENTION

The present invention relates generally to systems and, more specifically, to improvements to systems to an enhancement to electronic mail programs, messaging and collaboration programs that scan the sender's message text and determines that the sender intended to attach one or more attachments or include one or more external references, but no attachment(s) or reference(s) has been included, and warns the user before sending.

### BACKGROUND OF THE INVENTION

Many times, users of email will send along attachments, such as a photo or sound file, or external references, such as a URL, to their respective email messages. Or, sometimes, the email senders will intend to include an attachment(s)—but in their haste to send the email—forget to perform the steps necessary to include the attachment(s) or external reference(s). For instance, for the Microsoft Outlook email client, the steps required are:
1. Create or open the item in which you want to insert a file attachment. For messages, you must be creating a new message to insert an attachment.
2. Click in the body of the item, and then click Insert File [symbol] .
3. Select the file that you want to attach, and then click Insert.
4. In a new message, click Send, and in any other type of item, click Save and Close.

Other email clients, such as IBM's Lotus Notes business e-mail and collaboration client, include similar type necessary steps to include attachments or external references to (or in) an e-mail or other collaborative messages.

However, there is a problem in that many people using electronic mail programs and other messaging/collaboration systems intend to attach files or other attachments or include external references such as URLs, but often forget to do this. This mistake is often not discovered and corrected until hours/days later when recipients reply with “missing attachment” comments. This leads to frustration and “oops!” emails. In a commercial relationship, sending a customer an email missing an attachment is more than just frustrating and embarrassing, but casts a negative impression of the enterprise in the customer's mind, which can have financial consequences.

Most present systems use only a pure keyword/phrase exact match search to detect missing attachment intent, such as Microsoft Outlook Attachment Alarm—see http://www.office-addins.com/-outlook-addins/outlook-attachment-alarm.html). These systems examine, or scan, the email for keywords such as “Attachment” and, if they find the word “attachment” and no attachment is present, they notify the sender that that attachment is missing. Some include features whereby the user or the system can adjust keyword lists based on heuristics and experience. Others are a little more sophisticated to determine the number of intended attachments, again, based solely on simple keyword identification and simple syntactic clues (e.g., the presence of a number before a keyword as in “Here are 3 files”.)

There needs to be a system for detecting whether a sender of a collaboration message intends to include one or more attachments (such as a picture) or one or more external references (such as an URL), for determining whether the attachment(s) and/or external reference(s) are attached, for determining whether the attachment(s) and/or external reference(s) were indeed attached and, if not, notifying the sender.

### BRIEF SUMMARY OF THE INVENTION

The present invention provides a system and method to provide an enhancement to electronic mail programs, messaging and collaboration programs that scan the sender's message text and determines that the sender intended to attach one or more attachment(s) and/or external reference(s), but no attachment(s) and/or external reference(s) has been included, and warns the user before sending. The system and method identify variants of typical phraseology such as “attached is . . . ”, “Here is . . . ”, “This file . . . ”, “take a look at this . . . ”, etc., and determines that it was likely that the user meant to attach or refer to something.

The illustrative aspects of the present invention are designed to solve one or more of the problems herein described and/or one or more other problems not discussed.

### BRIEF DESCRIPTION OF THE SEVERAL VIEWS OF THE DRAWINGS

These and other features of the invention will be more readily understood from the following detailed description of the various aspects of the invention taken in conjunction with the accompanying drawings that depict various embodiments of the invention, in which:

FIG. 1 is a diagram which illustrates the system and method of the present invention showing a basic collaboration system comprising a User A communicating with User B.

FIG. 2 illustrates the process of the present invention in a flowchart form.

FIG. 3 further illustrates the system and method showing the present invention in flowchart form.

The drawings are intended to depict only typical aspects of the invention, and therefore should not be considered as limiting the scope of the invention. In the drawings, like numbering represent like elements between the drawings.

### DETAILED DESCRIPTION OF THE INVENTION

The present invention provides a system and method to electronic mail programs, messaging and collaboration programs that scan the sender's message text and determines that the sender intended to attach one or more attachment(s) or include one or more external reference(s), but no attachment(s) or reference(s) has been included, and warns the user before sending. The capability can also be extended to any messaging system (e.g., instant messaging) and collaboration system.

The system and method identify variants of typical phraseology such as “attached is . . . ”, “Here is . . . ”, “This file . . . ”, “take a look at this . . . ”, etc., and determines that it was likely that the user meant to attach or refer to something. The feature can be a user-selectable option whether to check for missing attachments/references. This feature could also be incorporated into mail-scanning “rules engines” as a term in a rule, such as “<message contents suggests attachment(s)> AND <number of attachments> EQUALS 0”.

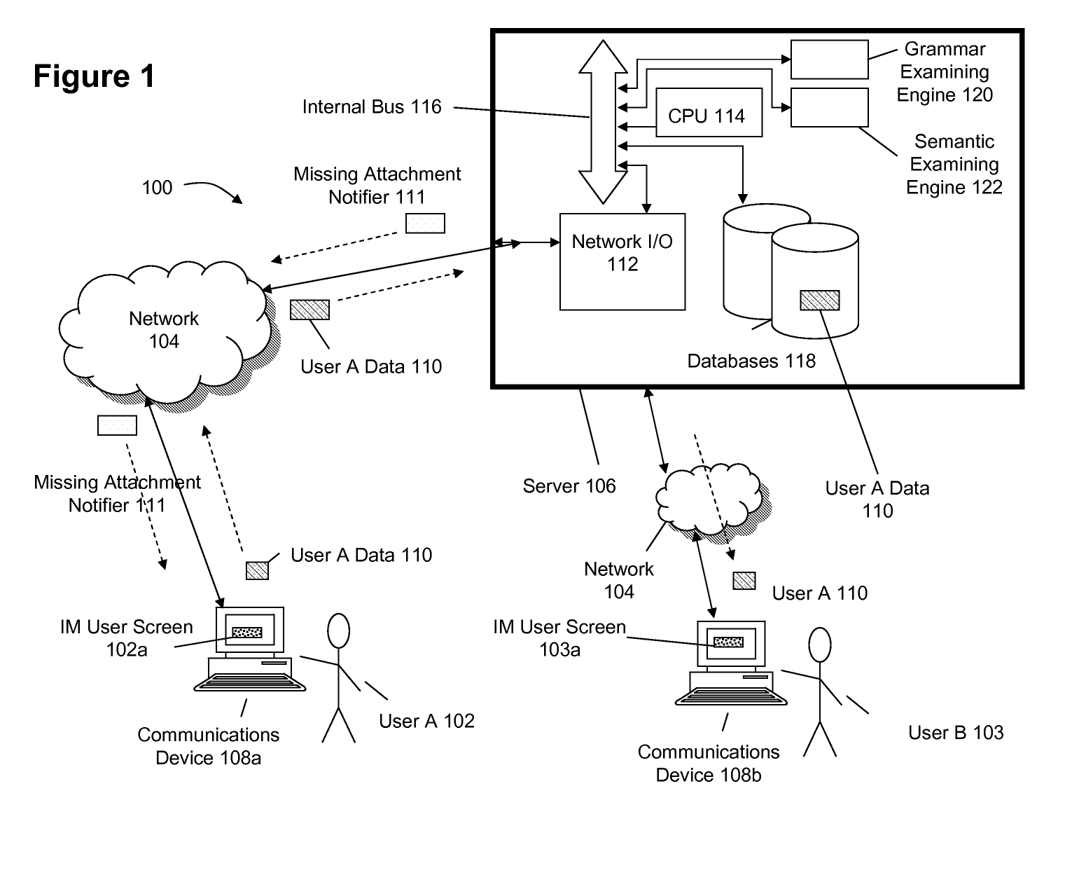

FIG. 1 illustrates a basic collaboration system 100 comprising a User A 102 communicating with User B 103. User A 102 sends User A Data 110 through Network 104 to Server 106. In the Server 106, it is stored in Databases 118 utilizing the Network I/O 112, the Internal Bus 116 and the CPU 116. Server 106 further has a Grammar Examining Engine 120 and a Semantics Examining Engine 122 for examining the User A Data 110. Grammar Examining Engine 120 examines the User A Data 110, or message, to analyze interaction sequences of words against grammar-style rules and then checking those rules for consistency and simplicity. Semantic Examining Engine 122 examines the User A Data 110 contextual-usage meaning of words by statistical computations applied to a large corpus of the text of the message. Grammar Examining Engine 120 and Semantic Examining Engine 122 provide sophisticated text analytics such as root word analysis (to cover variations of words such as “attachment” such as “I attach”, “I am attaching”, “attached are”, “see the attachment”, etc.) but they filter out false positives such as “I am very attached to Margaret” and “When I deleted the files . . . ” If it is determined by either the Grammar Examining Engine 120 or the Semantic Examining Engine 122, a Missing Attachment Notifier 111 is sent from Server 106 to User A 102.

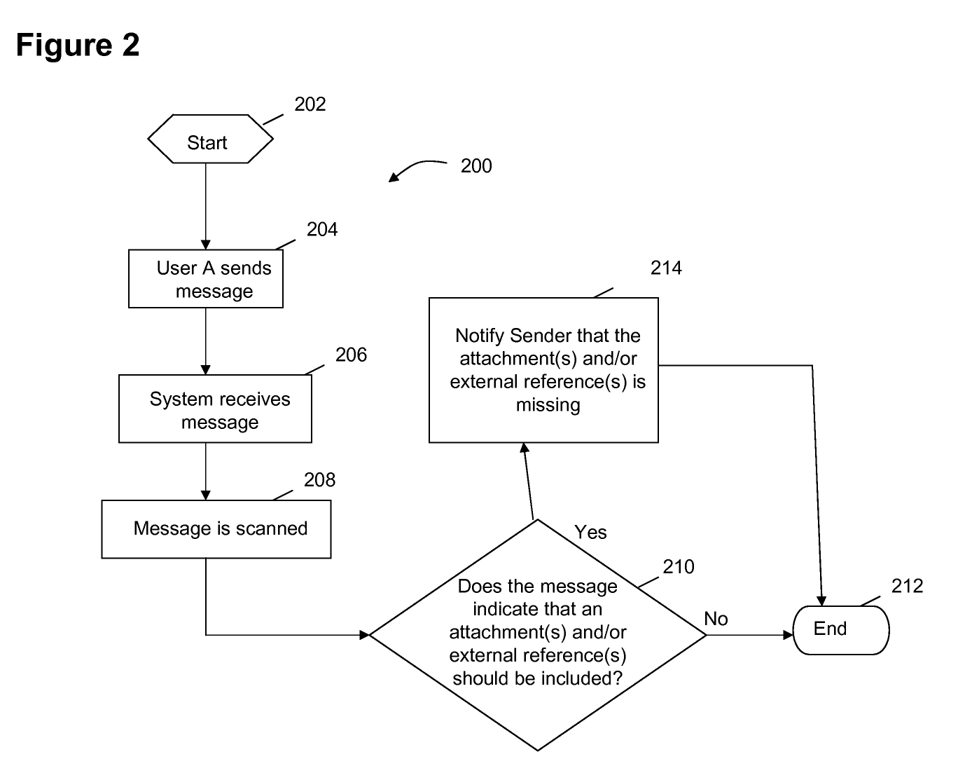

FIG. 2 illustrates a basic block diagram 200 to illustrate the method of the present invention. At 202, the process moves to User A sending a message at 204. At 206, the System receives the message. At 208, the System scans the message. At 210, the System determines whether the message indicates whether attachment(s) or external reference(s) should be included. If not, the Process is ended at End 212. If so, at 214, the System notifies the Sender that the attachment(s) or external reference(s) is missing.

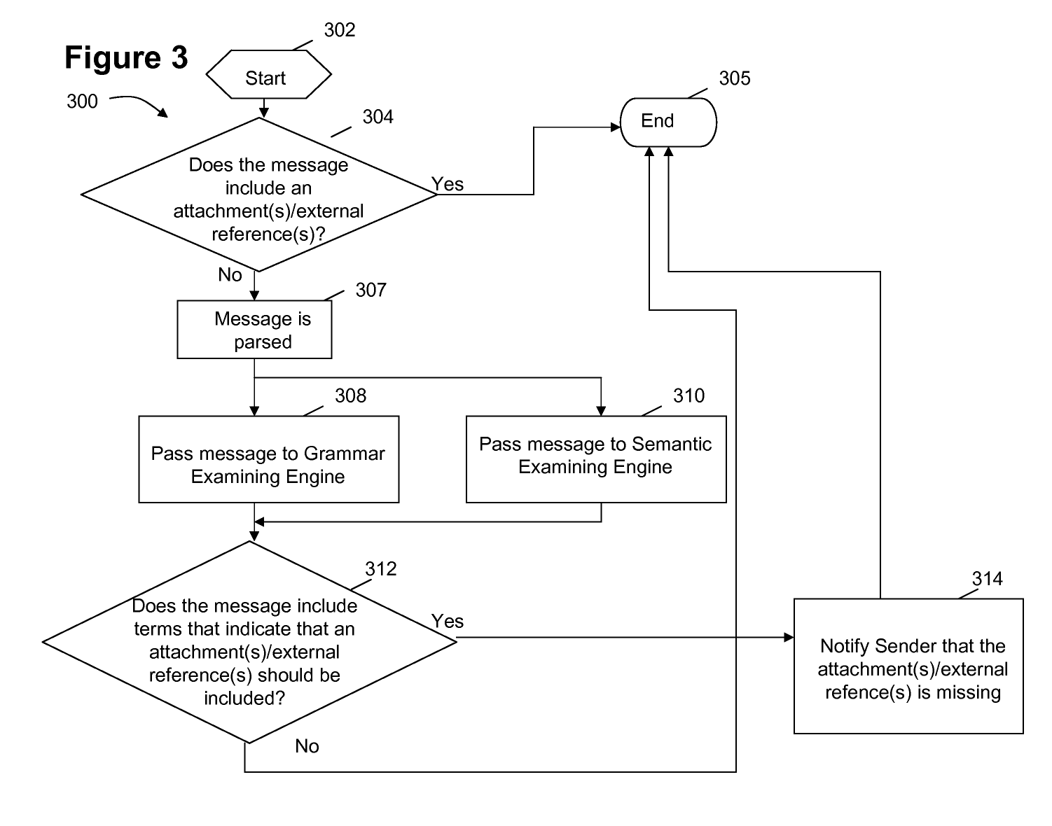

FIG. 3 illustrates a basic block diagram 300 to illustrate the method of the present invention. At 302, the method starts and proceeds to step 304 where, after a scan of the message, it is determined whether there is attachment(s) and/or external reference(s) included. If so, the method ends at 305. If not, the message is parsed at 307 and, at 308 and 310, passed to Grammar Examining Engine and the Semantic Examining Engine. At 312, it is determined whether the message indicates that there should be a message attached. If not, the method ends at 305. If so, a notifying message is sent to the sender at 314 and ends at 305.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

What is claimed is:

1. A method, in a collaboration system, such as an electronic mail or instant messaging system, for detecting one or more missing attachments and for detecting one or more missing external references in a collaboration system comprising communicating users wherein the users communicate by sending messages to one another using natural language words, terms, terminology and phraseology, the method comprising the steps of:
a. receiving a message from a sender;
b. determining whether the message has an attachment(s) or external reference(s); and
c. if not, performing the following steps:
1. examining the grammar of the message using natural language analysis;
2. examining the semantics of the message using natural language analysis;
3. determining whether an attachment(s) or external reference(s) was intended;
4. if so, notifying the sender that the intended attachment(s) was not attached or external reference(s) was not included.

2. The method of claim 1 wherein the semantics examining step 1c2 includes the step of identifying words which indicate that an attachment(s) or external reference(s) was intended.

3. The method of claim 2 wherein the semantics examining step 1c2 includes the step of examining the root of the words identified to determine whether an attachment(s) or external reference(s) was intended.

4. The method of claim 2 wherein the grammar examining step 1c1 includes the step of examining the identified phrase and determining whether the identified phrase has a misspelled word within the phrase.

5. The method of claim 3 wherein the semantics examining step 1c2 includes the step of examining whether the text includes false positives.

6. The method of claim 1 further including the step of detecting of the intention to supply a message attachment in foreign and multiple languages.

7. The method of claim 1 further comprising, after step a, the step of parsing the message.

8. A computer program product in a computer readable medium for operating in a system comprising a network I/O, a CPU, and one or more databases, for implementing a method, in a collaboration system, for detecting one or more missing attachments or one or more external references in a collaboration system comprising communicating users wherein the users communicate by sending messages to one another using natural language words, terms, terminology and phraseology, the method comprising the steps of:
a. receiving a message from a sender;
b. determining whether the message has an attachment(s) or external reference(s); and
c. if not, performing the following steps:
1. examining the grammar of the message using natural language analysis;
2. examining the semantics of the message using natural language analysis;
3. determining whether an attachment(s) or external reference(s) was intended;
4. if so, notifying the sender that the intended attachment(s) was not attached or external reference(s) was not included.

9. The computer program product according to claim 8 wherein the semantics examining step 8c2 includes the step of identifying words which indicate that an attachment(s) or external reference(s) was intended.

10. The computer program product according to claim 8 wherein the semantics examining step 8c2 includes the step of examining the root of the words identified to determine whether an attachment(s) or external reference(s) was intended.

11. The computer program product according to claim 8 wherein the grammar examining step 8c1 includes the step of examining the identified phrase and determining whether the identified phrase has a misspelled word within the phrase.

12. The computer program product according to claim 8 wherein the semantics examining step 8c2 includes the step of examining whether the text includes false positives.

13. The computer program product according to claim 8 wherein further including the step of detecting of the intention to supply a message attachment(s) or external reference(s) in foreign and multiple languages.

14. The computer program product according to claim 8 further having, after step a, the step of parsing the message.

15. A system for scanning, in a collaboration system, a sender's message text and determines that the sender intended to attach one or more attachments or include one or more external reference, but no attachment or reference has been included, and warns the user before sending, the system identifying variants of typical phraseology such as “attached is . . . ”, “Here is . . . ”, “This file . . . ”, “take a look at this . . . ”, etc., and determines that it was likely that the user meant to attach or refer to something using grammar, semantics and heuristics analysis, the system comprising:
a network input/output device to receive and forward messages;
one or more data stores to store the messages;
a CPU for processing the messages;
a grammar examining engine for examining the messages for grammatical identifiers to identify that an attachment(s) or external reference(s) was intended; and
a semantic examining engine for examining the messages for semantic identifiers to identify that an attachment(s) or external reference(s) was intended.

16. The system of claim 15 wherein the grammar and semantic examining engines identify variants of typical phraseology such as “attached is . . . ”, “Here is . . . ”, “This file . . . ”, “take a look at this . . . ”, etc., and determines that it was likely that the user meant to attach or refer to something.
